(19) United States
(12) Patent Application Publication
(10) Pub. No.: US 2026/0060180 A1
(43) Pub. Date: Mar. 5, 2026

(54) THRESHING SYSTEM OF A COMBINE HARVESTER

(71) Applicant: AGCO International GmbH, Neuhausen Am Rheinfall (CH)

(72) Inventor: Murillo Centenaro, Breganze (IT)

(21) Appl. No.: 19/318,572

(22) Filed: Sep. 4, 2025

(30) Foreign Application Priority Data
Sep. 4, 2024 (EP) 24425041.1

(51) Int. Cl. A01F 12/26; A01F 12/56

(52) U.S. Cl. CPC A01F 12/26; A01F 12/56

(57) ABSTRACT

A threshing system for a combine harvester has first to fourth drums, with a concave beneath the first drum and first and second grates for the second and third drums. The second grate has an engaged position beneath the third drum, and it can be driven from the engaged position, around the third drum, to a disengaged position over the third drum. During this disengagement, a space adjustment system moves the fourth drum to increase a space between the third and fourth drums to enable the second grate to pass through the space.

### FIELD

Embodiments of the present disclosure relate generally to combine harvesters, and in particular to the threshing system of the combine harvester.

### BACKGROUND

A combine harvester typically includes a crop cutting head (header) and a threshing system for detaching grains of cereal from the ears of cereal. A delivery system, known as the feederhouse, delivers the cut crop to the threshing system. The threshing system is for detaching grains of cereal from the ears of cereal. A separating apparatus is downstream of the threshing system, and a grain cleaning apparatus receives grain from the separating apparatus.

The header is typically in the form of a wide array of cutters and a delivery auger (or belt) to feed the cut material to the central feederhouse. The feederhouse is typically in the form of a conveyor chain with cross bars that transport the crop material.

There are various designs for the threshing system and for the separating apparatus (e.g. axial or transverse) as well as for the grain cleaning apparatus. However, in all designs, there is a flow of material from the threshing system to the separating apparatus, and between the separating apparatus and the grain cleaning unit, in particular from a stratification pan to the grain cleaning unit.

The threshing system typically comprises threshing rotors that rotate with respect to concave gratings (known simply as “concaves”). As mentioned above, the threshing rotors may be arranged transversally or longitudinally with respect to the direction of travel of the combine harvester.

The most traditional threshing systems is the transverse threshing system, commonly called “conventional” threshing, where the rotor combined with its static concave is placed transversally to the machine, receiving all the material coming from the feeding system in a perpendicular flow. This allows the material to be processed without the need for a change in direction.

One commonly used design of the threshing system has three drums. In the systems of the applicant, these are known as the threshing drum, beater drum and multi-crop separator (MCS) drum. This terminology is used in this disclosure, although other terminology for the three drum threshing system is equally valid.

The use of a second separator drum downstream of the beater drum (i.e., the MCS drum) improves the grain separation. However, in some crops, the MCS drum is not used, and for this purpose it is known to enable grates beneath the beater drum and the MCS drum to be swiveled out of position, so that the crop no longer passes through a narrow channel around the beater drum and around the MCS drum.

In one example, the beater and MSC grates are connected together in series, and they are driven backwards (with respect to the driving direction of the combine) from beneath the beater drum and MCS drum to a position where they have been rotated around over the MCS drum.

For some crop conditions and/or crop types it would be an advantage to add a fourth drum downstream of the MCS drum, again in order to increase the combine separating performance. However, there is then not enough space between the MCS drum and the additional drum to swivel the MCS drum grates or the combined beater and MCS drum grates.

There is therefore a need for a new mechanism which enables grates to be engaged and disengaged in a threshing system with four drums.

### BRIEF SUMMARY

The concepts underlying this disclosure are defined by the claims. According to examples in accordance with this disclosure, there is provided a threshing system for a combine harvester, comprising:

first to fourth drums arranged along a crop flow direction, each drum having an axis of rotation across the crop flow direction;

a concave beneath the first drum;

a first grate for the second drum and a second grate for the third drum, wherein the second grate has an engaged position beneath the third drum;

a grate disengagement system configured to drive the second grate from the engaged position, around the third drum, to a disengaged position over the third drum; and

a space adjustment system, for moving the fourth drum to increase a space between the third and fourth drums to enable the second grate to pass through the space when moving from the engaged position to the disengaged position.

This threshing system has four drums. To enable the grate of the third drum (i.e., the second grate) to be disengaged by rotating around the third drum, a spacing to the fourth drum is increased during the disengagement. In this way, the overall space taken up by the threshing system is kept low while enabling a fourth drum to be added.

The grate disengagement system for example comprises a rotor which is coupled to the second grate to rotate the second grate around the third drum and a lever between the rotor and the fourth drum, the lever being configured to push the fourth drum away from the third drum and then pull the fourth drum back towards the third drum when driving the second grate from the engaged position to the disengaged position. Thus, while rotating the second grate around the third drum using a rotor, a lever is driven by the rotor to push the fourth drum away to make space for the second grate to pass, and then the lever pulls the fourth drum back so that the four drums are returned to operative positions.

The lever is for example rotatably connected at one end to the rotor. Thus, it moves with and is driven by the rotor. This avoids the need for a separate drive system.

The fourth drum is for example connected to a pivot point by a pivot arm, and the lever is connected to the pivot arm. Thus, the pivot arm is used to push and pull the fourth drum between operative and spaced positions.

The grate disengagement system may further be configured to lower the first grate when driving the second grate from the engaged position to the disengaged position. In this way, the first grate is also disengaged when the second grate is disengaged.

The grate disengagement system for example comprises the rotor which is coupled to the second grate to rotate the second grate around the third drum (as also mentioned above) and a lever arrangement between the rotor and the first grate. Thus, the rotor rotation controls the movement of the first gate, the second grate and the spacing to the fourth drum.

The first grate is for example pivoted about a pivot axis parallel to a rotation axis of the second drum, wherein the lever arrangement pivots the first grate into an open state when driving the second grate from the engaged position to the disengaged position.

This disclosure also provides a combine harvester comprising:

a crop cutting head;

the threshing system as defined above; and

a grain separating and cleaning system for receiving the cut and threshed crop material.

### BRIEF DESCRIPTION OF THE DRAWINGS

One or more embodiments of the invention/disclosure will now be described, by way of example only, with reference to the accompanying drawings, in which:

FIG. 1 shows a combine harvester which may be adapted in accordance with the invention;

FIG. 2 shows one example of threshing system and grain cleaning apparatus in more detail;

FIG. 3 shows the rear end of a threshing system with four drums, together with a lever arrangement for controlling the position of the fourth drum;

FIG. 4 shows the lever arrangement of FIG. 3 in simplified functional form;

FIG. 5 shows the rotor position half way along the path to the disengaged position;

FIG. 6 shows the rotor in the disengaged position;

FIG. 7 shows the beater (second) drum and the MCS (third) drum and shows another lever arrangement for controlling the position of the beater grate;

FIG. 8 shows the lever arrangement of FIG. 7 in simplified functional form;

FIG. 9 shows the disengaged position of the arrangement of FIG. 7;

FIG. 10 shows a lever system which combines the two lever arrangements n the engaged position; and

FIG. 11 shows the lever positions of the lever system of FIG. 10 at the end of the disengagement operation.

### DETAILED DESCRIPTION

The invention will be described with reference to the Figures.

It should be understood that the detailed description and specific examples, while indicating exemplary embodiments of the apparatus, systems and methods, are intended for purposes of illustration only and are not intended to limit the scope of the invention. These and other features, aspects, and advantages of the apparatus, systems and methods of the present invention will become better understood from the following description, appended claims, and accompanying drawings. It should be understood that the Figures are merely schematic and are not drawn to scale. It should also be understood that the same reference numerals are used throughout the Figures to indicate the same or similar parts.

This disclosure relates to a threshing system for a combine harvester that has first to fourth drums, with a concave beneath the first drum and first and second grates for the second and third drums. The second grate has an engaged position beneath the third drum, and it can be driven from the engaged position, around the third drum, to a disengaged position over the third drum. During this disengagement, a space adjustment system moves the fourth drum to increase a space between the third and fourth drums to enable the second grate to pass through the space.

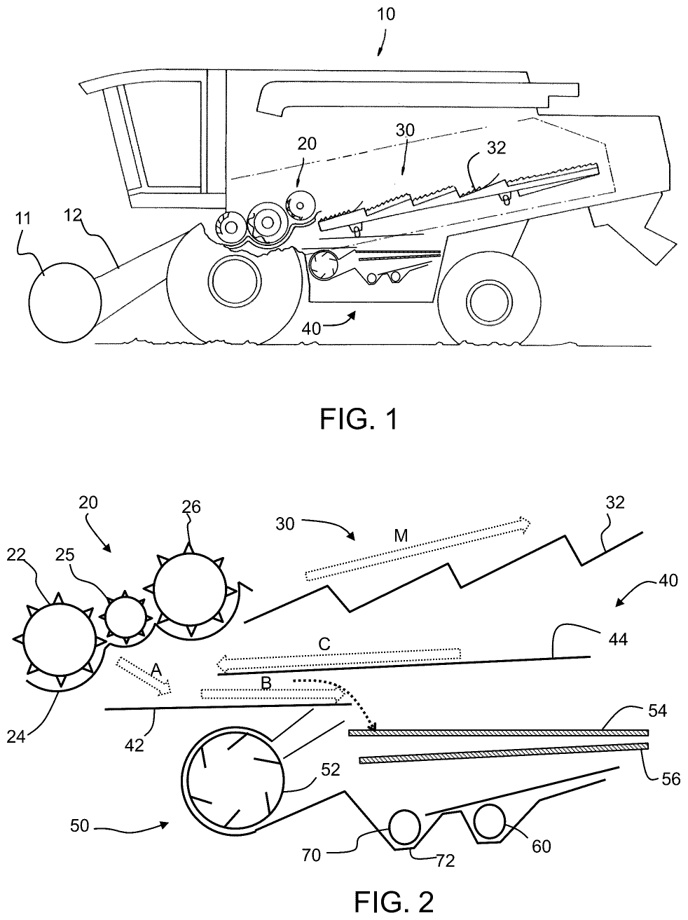

FIG. 1 shows a known combine harvester 10 to which the invention may be applied as a modification to the threshing system. A crop cutting head 11 (known as the header) for example comprises a wide laterally extending transverse auger, which cuts the crop material and drives it inwardly towards a central area. A front elevator housing 12 receives the cut crop material and includes a feederhouse for transporting the crop material.

The feederhouse delivers the crop material to a threshing system 20 for detaching grains of cereal from the ears of cereal, and a separating apparatus 30 which is connected downstream of the threshing system 20. The threshing system comprises one or more threshing units, in particular rotors, and associated concaves.

In the example shown, the separating apparatus 30 includes a plurality of parallel, longitudinally-aligned, straw walkers 32, and this is suitable for the case of a so-called straw-walker combine. The grains after separation by the separating device 30 pass to a grain cleaning apparatus 40.

The threshing system 20 is a tangential-flow ‘conventional’ threshing system, i.e. formed by rotating elements with an axis of rotation in the side-to-side direction of the combine harvester and for generating a tangential flow. For example, the ‘conventional’ threshing system includes a rotating, tangential-flow, threshing drum and a concave-shaped grate. The threshing drum includes rasp bars (not shown) which act upon the crop stream to thresh the grain or seeds from the remaining material, the majority of the threshed grain passing through the underlying grate and onto a stratification pan (also sometimes known as the grain pan).

In one known type of threshing system, as shown in FIG. 1, there is a beater drum after the threshing drum and a multi crop separator drum after the beater drum. Thus, it is well known to use three drums in the threshing system.

The threshing system 20, separating apparatus 30 and grain cleaning apparatus 40 are shown in more detail in FIG. 2.

The threshing system 20 includes a rotating, tangential-flow, threshing drum 22 and a concave-shaped grate 24. The threshing drum 22 includes rasp bars (not shown) which act upon the crop stream to thresh the grain or seeds from the remaining material, the majority of the threshed grain passing through the underlying grate 24 and onto a stratification pan 42 (also known as the grain pan).

The threshing system 20 also comprises a beater drum 25 (also with a transverse rotation axis and creating a tangential flow), downstream of the threshing drum and a tangential-flow multi-crop separator drum 26 (also with a transverse rotation axis and creating a tangential flow) downstream of the beater drum 25. They each have an associated grate beneath.

The remainder of the crop material including straw, tailings and un-threshed grain are passed from the threshing system 20 into the separating apparatus 30 as shown by arrow M.

In the example shown, the separating apparatus 30 includes a plurality of parallel, longitudinally-aligned, straw walkers 32, and this is suitable for the case of a so-called straw-walker combine. However, the separating apparatus 30 may instead include one or two longitudinally-aligned rotors which rotate about a longitudinal axis and convey the crop stream rearwardly in a ribbon passing along a spiral path. This is the case for a so-called axial or hybrid combine.

In all cases, the separating apparatus 30 serves to separate further grain from the crop stream, and this separated grain passes through a grate-like structure onto an underlying return pan 44. The residue crop material, predominantly made up of straw, exits the machine at the rear. Although not shown in FIG. 1, a straw spreader and/or chopper may be provided to process the straw material as required.

The threshing apparatus 20 and separating apparatus 30 do not remove all material other than grain, “MOG”, from the grain so that the crop stream collected by the stratification pan 42 and return pan 44 typically includes a proportion of straw, chaff, tailings and other unwanted material such as weed seeds, bugs, and tree twigs. The stratification pan 42 and return pan 44 are driven in an oscillating manner to convey the grain and MOG accordingly.

The remainder of the grain cleaning apparatus 40 (i.e. a grain cleaning unit 50) is provided to remove this unwanted material thus leaving a clean sample of grain to be delivered to the tank.

The grain cleaning unit 50 comprises a fan unit 52 and sieves 54 and 56. The upper sieve 54 is known as the chaffer.

The grain passing through concave grate 24 falls onto the front of the stratification pan 42 as indicated by arrow A in FIG. 2. This material is conveyed rearwardly (in the direction of arrow B in FIG. 2) by the oscillating motion of the stratification pan 42 and the ridged construction thereof. Material passing through the grate of the separator apparatus 30 falls onto the return pan 44 and is conveyed forwardly by the oscillating motion and ridged construction thereof as shown by arrow C. It is noted that “forwardly” and “rearwardly” refer to direction relative to the normal forward direction of travel of the combine harvester.

When the material reaches a front edge of the return pan 44 it falls onto the stratification pan 42 and on top of the material conveyed from the threshing system 20 as indicated by arrow B.

The combined crop streams thus progress rearwardly towards a rear edge of the stratification pan 42. Whilst conveyed across the stratification pan 42, the crop stream, including grain and MOG, undergoes stratification wherein the heavier grain sinks to the bottom layers adjacent stratification pan 42 and the lighter and/or larger MOG rises to the top layers.

Upon reaching the rear edge of the stratification pan 42, the crop stream falls onto the chaffer 54 which is also driven in a fore-and-aft oscillating motion. The chaffer 54 is of a known construction and includes a series of transverse ribs or louvers which create open channels or gaps therebetween. The chaffer ribs are angled upwardly and rearwardly so as to encourage MOG rearwardly whilst allowing the heavier grain to pass through the chaffer onto an underlying second sieve 56. The chaffer 54 is coarser (with larger holes) than second sieve 56.

MOG which reaches the rear section either passes over the rear edge and out of the machine or through the associated grate before being conveyed to a returns auger 60 for re-threshing in a known manner. The majority of materials passing through the rear end of the chaffer 54 is un-threshed tailings.

Grain passing through chaffer 54 is incident on the lower sieve 56 which is also driven in an oscillating manner and serves to remove tailings from the stream of grain before being conveyed to on-board tank (not shown) by grain collecting auger 70 which resides in a transverse trough 72 at the bottom of the grain cleaning unit 50. Tailings blocked by sieve 56 are conveyed rearwardly by the oscillating motion thereof to a rear edge from where the tailings are directed to the returns auger 60 for reprocessing in a known manner.

This disclosure relates to the design of the threshing system, and in particular it relates to a threshing system with an added fourth drum.

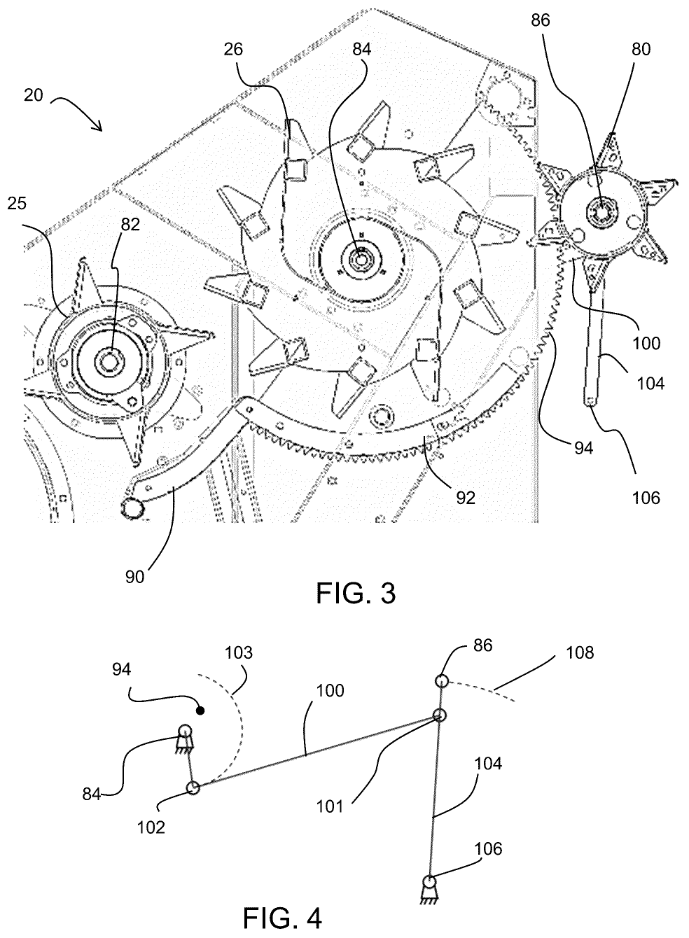

FIG. 3 shows the rear end of the threshing system 20, and shows the second drum, namely the beater drum 25, the third drum, namely the multi-crop separator drum 26 and a fourth drum 80. Thus, there are first to fourth drums arranged along the crop flow direction. Each drum has an axis of rotation across the crop flow direction. The beater drum 25 has rotation axis 82, the MCS drum 26 has rotation axis 84 and the fourth drum has rotation axis 86.

A first grate 90 is associated with the beater drum 25 and a second grate 92 is associated with the MCS drum 26. FIG. 3 shows an engaged position of the first and second grates 90, 92, wherein the first grate is beneath the beater drum to define a flow passageway between them, and the second grate is beneath the MCS drum to define a flow passageway between them.

The second grate 92 can be rotated around the MCS drum 26 so that it is moved from a position beneath the MCS drum to a position above the MCS drum. A grate disengagement system is provided for this purpose, which is configured to drive the second grate 92 from the engaged position, around the MCS drum 26, to the disengaged position over the MCS drum. The grate disengagement system comprises a rotor 94, in the form of a cog in this example, to which the second grate is fixed, so that when the rotor 94 is driven to rotate (e.g. by a meshed driving cog), the second grate is rotated, about the axis of rotation 84 of the MCS drum. The first and second grates 90, 92 are separately mounted.

The movement of the second grate requires it to pass between the MCS drum 26 and the fourth drum 80, but the meshing drum teeth prevent sufficient space being available.

The grate disengagement system thus further comprises a space adjustment system, for moving the fourth drum 80 to increase a space between the MCS (third) drum 26 and the fourth drum 80, to enable the second grate 92 to pass through the space when moving from the engaged position to the disengaged position.

By increasing the spacing to the fourth drum during the disengagement of the second grate, space is provided to rotate the second grate around the MCS drum.

The grate disengagement system comprises a lever between the rotor and the fourth drum, wherein the lever is configured to push the fourth drum away from the third drum and then pull the fourth drum back towards the third drum when driving the second grate from the engaged position to the disengaged position.

The lever arrangement is shown in simplified functional form in FIG. 4.

The rotor 94 rotates about the fixed rotation axis 84 of the MCS drum. A lever 100 is connected at one end to an off-center location 102 of the rotor 94, and the path of that location 102 is shown as 103 in FIG. 4. The other end of the lever 100 is connected at a pivot point 101 to a pivot arm 104. The pivot arm is connected to a fixed location 106 at one end and connects to the fourth drum 80 at the other end, for example it connects to the rotation axis 86. When the rotor 94 rotates, for example by approximately 180 degrees as shown dotted in FIG. 4, the rotation axis 86 moves away from the MCS drum and then back again, hence following the path 108 (twice-out and back).

The lever 100 and the pivot arm 104 can be seen in FIG. 3, which shows the engaged position of the second grate 92.

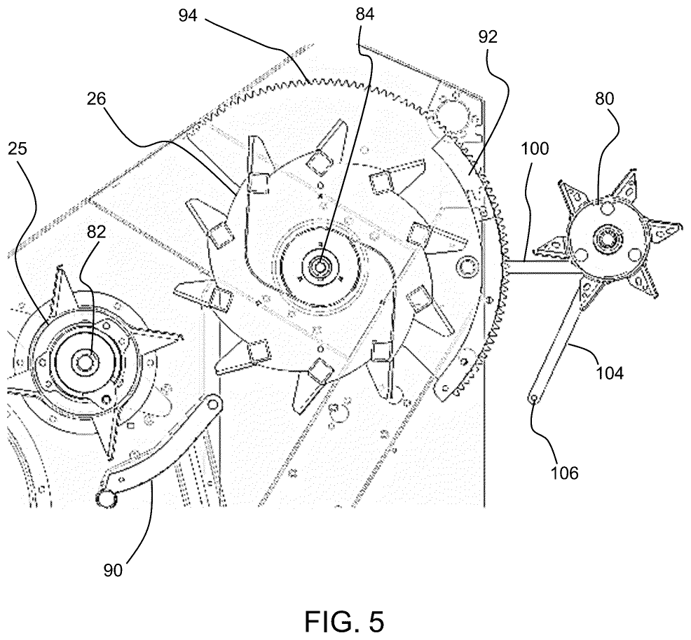

FIG. 5 shows the rotor position half way along the arcuate path to the disengaged position, when the fourth drum 80 is spaced from the MCS drum 26 to allow the second grate 92 to pass.

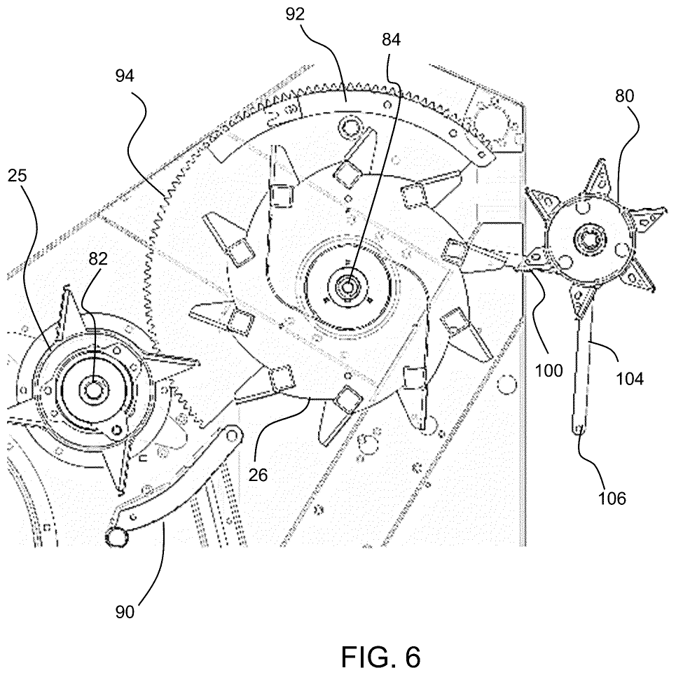

FIG. 6 shows the rotor in the disengaged position when the fourth drum 80 has returned back to the engaged position, with the second grate 92 over the top of the MCS drum 26.

Thus, while rotating the second gate around the third drum, a lever arrangement 100, 104 is driven by the rotor 94 to push the fourth drum 80 away to make space for the second grate to pass, and then the lever arrangement 100, 104 pulls the fourth drum back so that the four drums are in operative positions.

In FIGS. 3, 5 and 6, the first grate 90 is shown to remain in the same position during adjustment of the second grate 92. In a further refinement, the grate disengagement system is also configured to lower the first grate 90 when driving the second grate 92 from the engaged position to the disengaged position. In this way, the first grate 90 is also disengaged when the second grate 92 is disengaged.

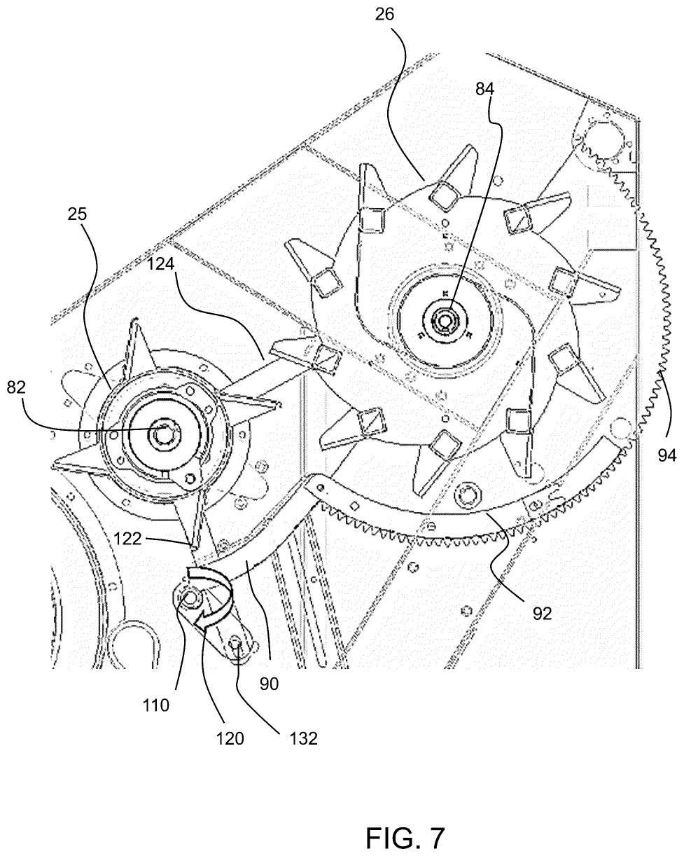

FIG. 7 shows the beater drum 25 (the second drum) and the MCS drum 26 (the third drum).

Another lever arrangement is provided between the rotor 94 and the first grate 90. Thus, the rotor rotation controls movement of the first gate 90, the second grate 92 and the spacing to the fourth drum 80 (not shown in FIG. 7).

The first grate is pivoted about a pivot axis 110 parallel to a rotation axis of the second drum (or indeed any drum as their axes of rotation are all parallel to each other). Between this pivot axis 110 and the rotor 94 there are arms 120, 122, 124 forming a second lever arrangement. The second lever arrangement pivots the first grate into an open state when driving the second grate from the engaged position to the disengaged position.

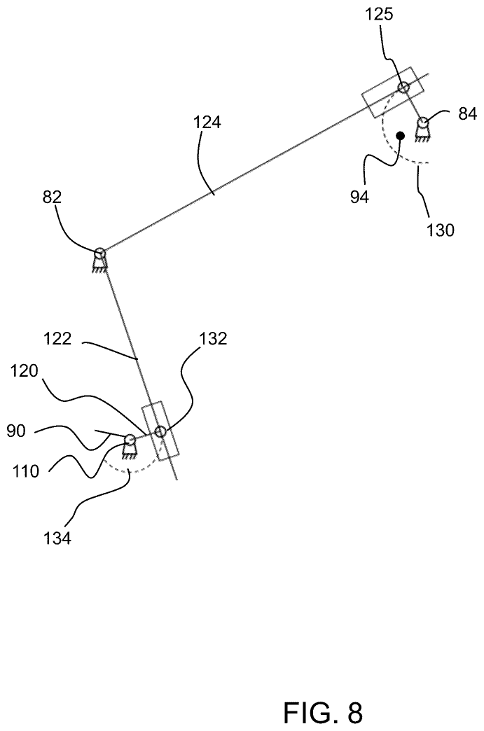

The lever arrangement is shown in simplified functional form in FIG. 8.

The rotation of the rotor 94 causes the end 125 of the lever 124 to follow the path 130. Levers 124 and 122 form a rigid L-shape, which can rotate about the rotation axis 82. This entrains rotation of lever 120 about the fixed pivot axis 110 and the connection 132 between them follows the path 134. This adjusts the angles of the lever 120 and the first grate 90 (because they are fixed relative to each other). The connections 125 and 132 are sliding rotary connections.

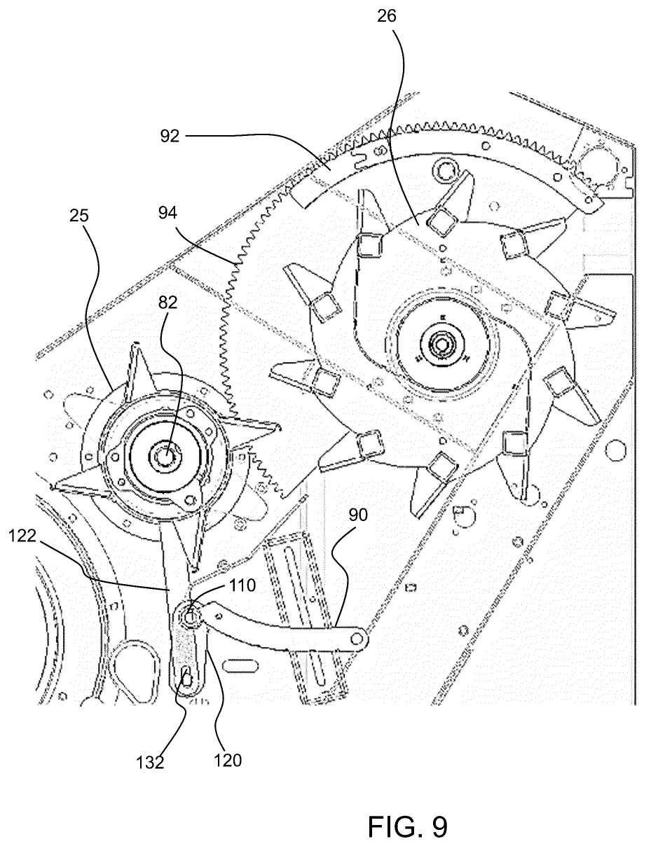

FIG. 7 shows the engaged position. FIG. 9 shows the disengaged position in which the first grate 90 has been lowered to increase the gap to the beater drum 25.

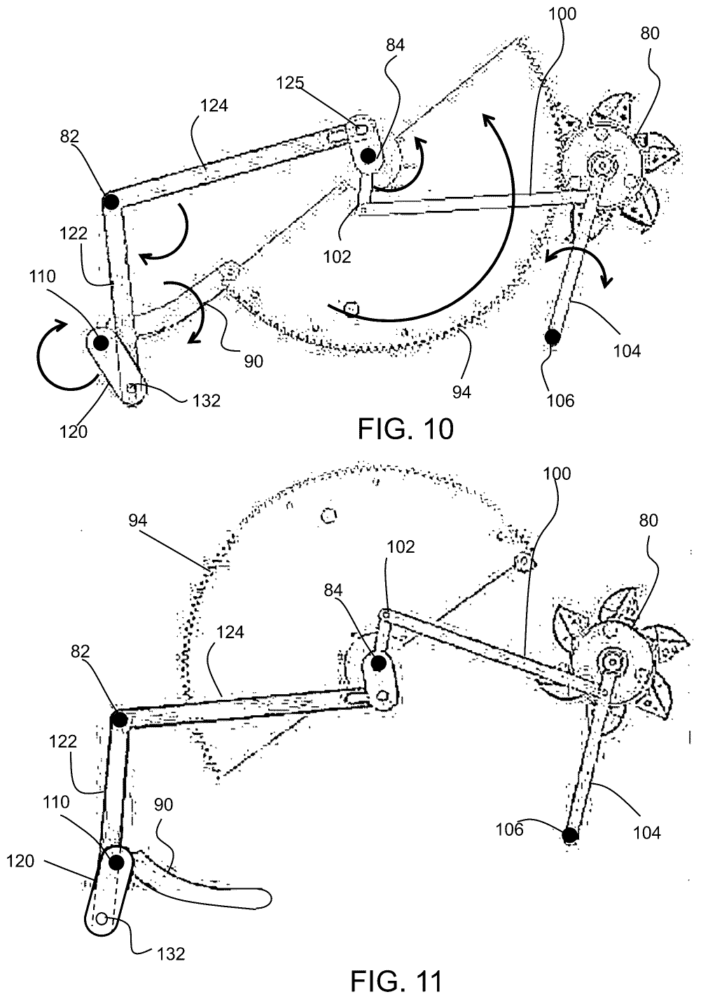

FIG. 10 shows a lever system which combines the two lever arrangements described above. The arrows show the movement of the parts of the system during disengagement. As shown, the fourth drum has a reciprocal movement driven by pivot arm 104 in that it is moved away and then back.

FIG. 10 shows the lever positions at the beginning of the disengagement operation, and FIG. 11 shows the lever positions at the end of the disengagement operation.

It will be understood that opening the first grate (for the beater drum) is only one option. The first and second grates may instead be coupled together so that they are both rotated around the MCS drum when the fourth drum is spaced. However, the fourth drum should be able to return to its non-spaced position without interfering with the first and second grates in their displaced positions.

The lever system shown is merely one possible example. The core function of spacing the fourth drum to make space to pass the MCS grate (and optionally also the beater grate as mentioned above) can be achieved with different drive arrangements. However, most preferably, the rotational positioning of the MCS grate entrains the movement of the fourth drum, so that there is a linkage between the drive arrangement for setting the MCS grate location and the drive arrangement for setting the fourth drum position. In one option, the rotational positioning of the MCS grate also entrains the movement of the first grate, so that there is a linkage between the drive arrangement for setting the MCS grate location and the drive arrangement for setting the first grate position.

Variations to the disclosed embodiments can be understood and effected by those skilled in the art in practicing the claimed invention, from a study of the drawings, the disclosure and the appended claims. In the claims, the word “comprising” does not exclude other elements or steps, and the indefinite article “a” or “an” does not exclude a plurality.

The mere fact that certain measures are recited in mutually different dependent claims does not indicate that a combination of these measures cannot be used to advantage.

Any reference signs in the claims should not be construed as limiting the scope.

All references cited herein are incorporated herein in their entireties. If there is a conflict between definitions herein and in an incorporated reference, the definition herein shall control.

1. A threshing system for a combine harvester, comprising:
first to fourth drums arranged along a crop flow direction, each drum having an axis of rotation across the crop flow direction;
a concave beneath the first drum;
a first grate for the second drum and a second grate for the third drum, wherein the second grate has an engaged position beneath the third drum;
a grate disengagement system configured to drive the second grate from the engaged position, around the third drum to a disengaged position over the third drum; and
a space adjustment system, for moving the fourth drum to increase a space between the third and fourth drums to enable the second grate to pass through the space when moving from the engaged position to the disengaged position.

2. The threshing system of claim 1, wherein the grate disengagement system comprises a rotor which is coupled to the second grate to rotate the second grate around the third drum and a lever between the rotor and the fourth drum, the lever being configured to push the fourth drum away from the third drum and then pull the fourth drum back towards the third drum when driving the second grate from the engaged position to the disengaged position.

3. The threshing system of claim 2, wherein the lever is rotatably connected at one end to the rotor.

4. The threshing system of claim 1, wherein the rotor comprises a cog.

5. The threshing system of claim 1, wherein the fourth drum is connected to a pivot point by a pivot arm, and the lever is connected to the pivot arm.

6. The threshing system of any one of claim 1, wherein the grate disengagement system is further configured to lower the first grate when driving the second grate from the engaged position to the disengaged position.

7. The threshing system of claim 6, wherein the grate disengagement system comprises a rotor which is coupled to the second grate to rotate the second grate around the third drum and a lever arrangement between the rotor and the first grate.

8. The threshing system of claim 7, wherein the first grate is pivoted about a pivot axis parallel to a rotation axis of the second drum wherein the lever arrangement pivots the first grate into an open state when driving the second grate from the engaged position to the disengaged position.

9. A combine harvester comprising:
a crop cutting head
the threshing system of claim 1; and
a grain separating and cleaning system for receiving the cut and threshed crop material.
